(19) United States
(12) Patent Application Publication
(10) Pub. No.: US 2017/0050276 A1
(43) Pub. Date: Feb. 23, 2017

(54) Work System, Composite System, and Robotic System

(71) Applicant: Seiko Epson Corporation, Tokyo (JP)

(72) Inventor: Shiguma Iijima, Suwa-shi (JP)

(21) Appl. No.: 15/232,083

(22) Filed: Aug. 9, 2016

(30) Foreign Application Priority Data
Aug. 17, 2015 (JP) 2015-160327

(51) Int. Cl. B23P 21/00; B25J 21/00; B23P 23/06

(52) U.S. Cl. CPC B23P 21/004; B23P 23/06; B25J 21/00

(57) ABSTRACT

A work system is for performing a work operation including a plurality of operation processes on an object, and includes a plurality of plates, lengths of the plates in a first direction in which the work operation including the plurality of operation processes is performed each have a value obtained by multiplying a predetermined value by a natural number, and intervals between the plates adjacent to each other in the first direction each have a value obtained by multiplying the predetermined value by an integer one of equal to and larger than 0.

### BACKGROUND

1. Technical Field

The present invention relates to a work system, a composite system, and a robotic system.

2. Related Art

There has been studied a technique and a method of making it easy to reassemble a line configuration so as to fit the product to be the production object in the production line for manufacturing electrical components and electronic components.

In this regard, there has been known robot cells each having the same width and each provided with a robot for assembling the component (see JP-A-2011-224742 (Document 1)).

However, even if the cells the same in size and each incorporating a robot are configured so as to be able to be reassembled as described in Document 1, it is not possible to deal with a plurality of types of process changes, and it is difficult to obtain a work system with versatility.

### SUMMARY

An aspect of the invention is directed to a work system adapted to perform a work operation including a plurality of operation processes on an object, including a plurality of plates, wherein lengths of the plates in a first direction in which the work operation including the plurality of operation processes is performed each have a value obtained by multiplying a predetermined value by a natural number, and intervals between the plates adjacent to each other in the first direction each have a value obtained by multiplying the predetermined value by an integer one of equal to and larger than 0.

According to this configuration, in the work system, the lengths of the plates in the first direction, in which the work operation including the plurality of operation processes is performed, each have the value obtained by multiplying the predetermined value by the natural number, and the interval between the plates adjacent to each other in the first direction has the value obtained by multiplying the predetermined value by the integer equal to or larger than 0. Thus, in the work system, it becomes easy to reorder the sequence of the operation processes performed in respective parts of the plurality of plates arranged in the first direction. As a result, it is possible for the work system to provide the user with a versatile usage corresponding to the object.

In another aspect of the invention, the work system may be configured such that the intervals between the plates adjacent to each other in the first direction are all 0.

According to this configuration, in the work system, the intervals between the plates adjacent to each other in the first direction are all 0. Thus, in the work system, it is possible to perform the work operation including the operation processes, which are performed by setting all of the intervals between the plates adjacent to each other in the first direction to 0.

In another aspect of the invention the work system may be configured such that at least one of the intervals between the plates adjacent to each other in the first direction has a value obtained by multiplying the predetermined value by an integer one of equal to and larger than 1.

According to this configuration, in the work system, at least one of the intervals between the plates adjacent to each other in the first direction is a value obtained by multiplying the predetermined value by an integer equal to or larger than 1. Thus, it is possible for the work system to perform the work operation including the operation processes, which are performed by setting at least one of the intervals between the plates adjacent to each other in the first direction to the value obtained by multiplying the predetermined value by the integer equal to or larger than 1.

In another aspect of the invention, the work system may be configured such that the work system further includes a conveying section adapted to convey the object in the first direction.

According to this configuration, the work system conveys the object in the first direction. Thus, in the work system, it is possible to perform the work operation including the operation processes, which are performed by conveying the object in the first direction.

In another aspect of the invention, the work system may be configured such that the conveying section is a belt conveyor.

According to this configuration, in the work system, the object is conveyed in the first direction using the belt conveyor. Thus, in the work system, it is possible to perform the work operation including the operation processes, which are performed by conveying the object in the first direction using the belt conveyor.

In another aspect of the invention, the work system may be configured such that, in a case of sectioning each of the plates in the first direction by the length of the predetermined value, each of the plates is provided with a first attachment part at a same position in every section.

According to this configuration, in the work system, in the case of sectioning each of the plates in the first direction by the length of the predetermined value, each of the plates is provided with the first attachment part at the same position in every section. Thus, in the work system, it is possible to attach the plate to another physical body by the length obtained by multiplying the predetermined value by a natural number using the first attachment part.

In another aspect of the invention, the work system may be configured such that the work system further includes a mounting part on which the plurality of plates is mounted, and in a case of sectioning the mounting part in the first direction by the length of the predetermined value, the mounting part is provided with a second attachment part to which the plate is attached at a same position in every section.

According to this configuration, in the work system, in the case of providing the sections with the length of the predetermined value in the first direction, the mounting part is provided with the second attachment part for attaching the plates at the same positions in every section. Thus, in the work system, it is possible to attach the plate to the mounting part by the length obtained by multiplying the predetermined value by a natural number using the second attachment part.

In another aspect of the invention, the work system may be configured such that some or all of the plates are each provided with a unit for the work operation.

According to this configuration, in the work system, some or all of the plates are each provided with the unit for the work operation. Thus, it is possible in the work system to perform the operation processes by the units provided to some or all of the plates in the respective operation processes.

In another aspect of the invention, the work system may be configured such that at least one of the units is a robot.

According to this configuration, in the work system, at least one of the units is the robot. Thus, it is possible in the work system to perform the operation process by the robot as at least one of the units in the operation process.

In another aspect of the invention, the work system may be configured such that the lengths of the units in the first direction are one of equal to and smaller than the predetermined value.

According to this configuration, in the work system, the lengths of the units in the first direction are equal to or smaller than the predetermined value. Thus, it is possible in the work system to provide the unit to each of the plates.

In another aspect of the invention, the work system may be configured such that the plurality of plates includes the plate different in length in a second direction perpendicular to the first direction.

According to this configuration, in the work system, the plurality of plates includes the plate different in length in a second direction perpendicular to the first direction. Thus, it is possible in the work system to perform the work operation using the plate having a length different in the second direction.

In another aspect of the invention, the work system may be configured such that the predetermined value is 100 millimeters.

According to this configuration, in the work system, the predetermined value is 100 millimeters. Thus, in the work system, it becomes easy to reorder the sequence of the operation processes performed in respective parts of the plates 10 having a length in the first direction expressed by a round-off value. As a result, it is possible for the work system to provide the user with a versatile usage corresponding to the object.

Still another aspect of the invention is directed to a composite system including a first work system as any one of the work systems described above, and a second work system, which is any one of the work systems described above, and is provided with the operation process different from the operation process worked in the first work system, wherein the plate provided to the first work system and the plate provided to the second work system are exchangeable for each other.

According to this configuration, in the composite system, the plate provided to the first work system and the plate provided to the second work system are exchangeable for each other. Thus, it is possible for the composite system to exchange the plates between the plurality of work systems.

Yet another aspect of the invention is directed to a robotic system in which a robot performs a part or a whole of a plurality of operation processes on an object, the robotic system including the robot, and a plurality of plates, wherein some of the plates are provided with the robot, lengths of the plates in a first direction in which a work operation including the plurality of operation processes is performed each have a value obtained by multiplying a predetermined value by a natural number, and intervals between the plates adjacent to each other in the first direction each have a value obtained by multiplying the predetermined value by an integer one of equal to and larger than 0.

According to this configuration, in the robotic system, the lengths of the plates in the first direction, in which the work operation including the plurality of operation processes is performed, each have the value obtained by multiplying the predetermined value by the natural number, and the interval between the plates adjacent to each other in the first direction has the value obtained by multiplying the predetermined value by the integer equal to or larger than 0. Thus, in the robotic system, it becomes easy to reorder the sequence of the operation processes performed in respective parts of the plurality of plates in a straight line along the first direction. As a result, it is possible for the robotic system to provide the user with a versatile usage corresponding to the object.

According to the above, in the work system, the composite system, and the robotic system, the lengths of the plates in the first direction, in which the work operation including the plurality of operation processes is performed, each have the value obtained by multiplying the predetermined value by the natural number, and the interval between the plates adjacent to each other in the first direction has the value obtained by multiplying the predetermined value by the integer equal to or larger than 0. Thus, it is possible for the work system, the composite system, and the robotic system to provide the user with a versatile usage corresponding to the object.

### BRIEF DESCRIPTION OF THE DRAWINGS

The invention will be described with reference to the accompanying drawings, wherein like numbers reference like elements.

FIG. 1 is a diagram showing an example of a plurality of plates constituting a work system 1 according to an embodiment of the invention, and an example of a mounting part on which these plates are mounted.

FIG. 2 is a diagram showing an example of a configuration of a part of a watch assembly line (a watch assembly system) 2 to which the work system 1 is applied.

FIG. 3 is a diagram showing an example of a plurality of rectangular plates 10 and a mounting part 20 constituting a work system 3.

FIG. 4 is a diagram showing an example of the plurality of rectangular plates 10, a rectangular plate 10a, and the mounting part 20 constituting a work system 4.

FIG. 5 is a diagram showing an example of a work system 5 provided with sector plates 11.

FIG. 6 is a diagram showing an example of first attachment parts provided to the plurality of rectangular plates 10 and the rectangular plate 10a shown in FIG. 4.

FIG. 7 is a diagram showing an example of second attachment parts provided to the mounting part 20 shown in FIG. 4.

### DESCRIPTION OF AN EXEMPLARY EMBODIMENT

### Embodiment

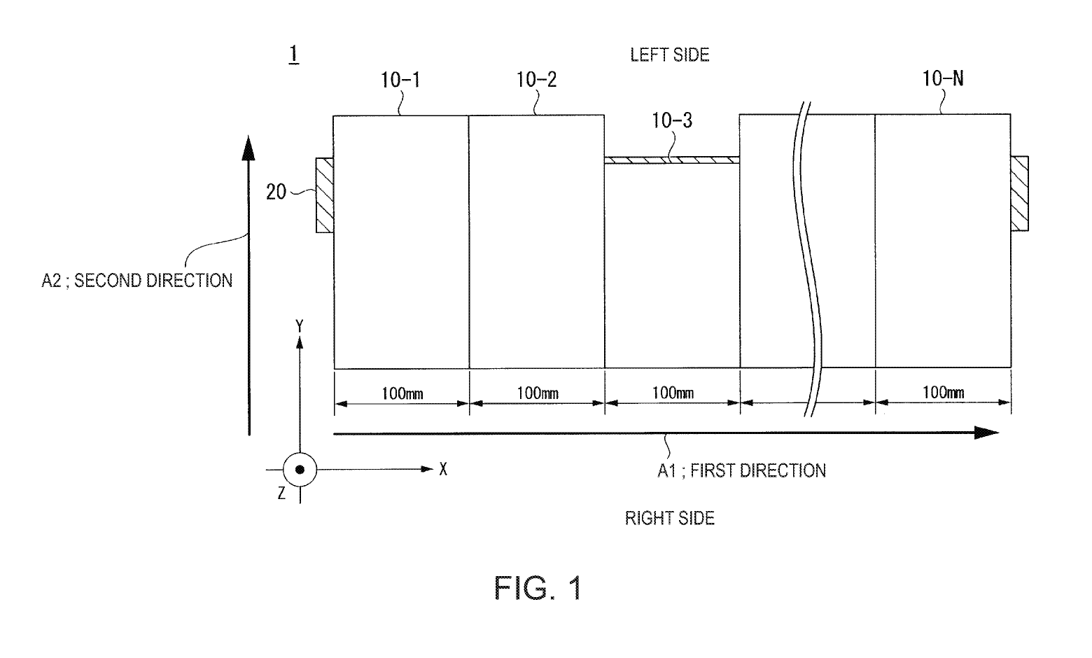

An embodiment of the invention will hereinafter be described with reference to the accompanying drawings. FIG. 1 is a diagram showing an example of a plurality of plates constituting a work system 1 according to the present embodiment, and an example of a mounting part on which these plates are mounted. The work system 1 is a work system for performing a work operation including a plurality of operation processes on an object. For example, the work system 1 is incorporated in a watch assembly line for performing a mechanical assembly work of a watch provided with a plurality of manufacturing processes as the work operation including the plurality of operation processes. In this case, the object is, for example, a component of the watch. It should be noted that the object is not limited to such a component, but can also be a component of an electronic apparatus such as a printer, a component of other devices, a physical body, a living body, or the like.

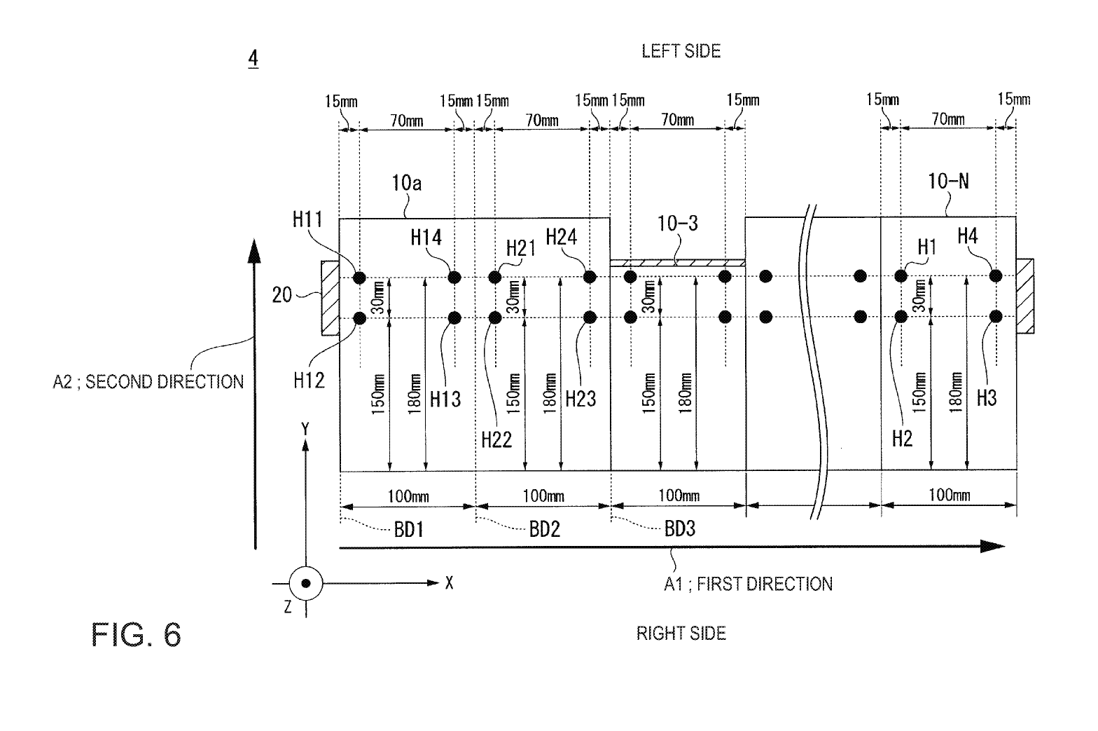

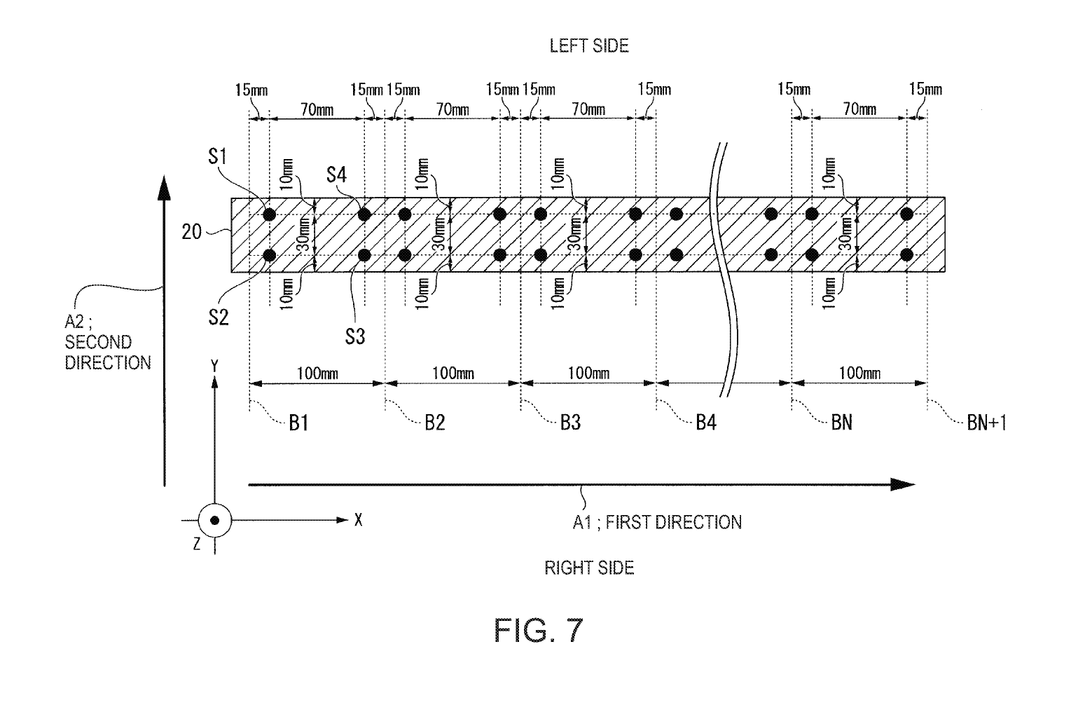

Here, the drawings for explaining the present embodiment are shown using an XYZ Cartesian coordinate system for the sake of convenience of explanation. More specifically, in FIG. 1 through FIG. 7, the explanation will be presented assuming that a direction from the left side of the sheet toward the right side is an X-axis direction (+X direction). Further, the explanation will be presented assuming that a direction perpendicular to the X-axis direction and originated from the lower side of the sheet toward the upper side is a Y-axis direction (+Y direction), and a direction from the back side of the sheet toward the front side is a Z-axis direction (+X direction). Further, the explanation will be presented assuming that the +X direction is a frontward direction (−X direction is a backward direction), the +Y direction is a leftward direction (−Y direction is a rightward direction), and the +Z direction is an upward direction (−Z direction is a downward direction). It should be noted that the “LEFT SIDE” shown in FIG. 1 through FIG. 4, FIG. 6, and FIG. 7 represents the +Y direction, and the “RIGHT SIDE” shown in FIG. 1 through FIG. 4, FIG. 6, and FIG. 7 represents the −Y direction.

In FIG. 1, as an example, there is shown the case in which the work system 1 is installed so that a first direction A1 as a direction, in which the work operation including the plurality of operation processes in the work system 1 is performed, coincides with the +X direction. Therefore, a second direction A2 perpendicular to the first direction A1 coincides with the +Y direction. It should be noted that there is no need for the first direction A1 in the work system 1 to coincide with the +X direction, and there is no need for the second direction A2 in the work system 1 to coincide with the +Y direction. These are illustrative only.

An outline of the work system 1 will be described. In the work system 1, the lengths of plates in the first direction A1, in which the work operation including the plurality of operation processes is performed, are each a value obtained by multiplying a predetermined value by a natural number, and an interval between the plates adjacent to each other in the first direction A1 is a value obtained by multiplying the predetermined value by an integer. Thus, in the work system 1, it becomes easy to reorder the sequence of the operation processes performed in respective parts of the plurality of plates arranged (mounted) in the first direction A1. As a result, it is possible for the work system 1 to provide the user with a versatile usage corresponding to the object.

The predetermined value is, for example, 100 millimeters. It should be noted that the predetermined value can also be a value smaller than 100 millimeters, or can also be a value larger than 100 millimeters instead of 100 millimeters. Hereinafter, as an example, there will be described the case in which each of the plates provided to the work system 1 is a rectangular plate having a rectangular shape (or a square shape). It should be noted that the natural number represents an integer equal to or greater than 1, and the integer represents an integer equal to or greater than 0.

As shown in FIG. 1, the work system 1 is provided with at least N rectangular plates 10-1 through 10-N, and a mounting part 20. The value N is an integer equal to or greater than 1. Hereinafter, the explanation will be presented referring to the N rectangular plates 10-1 through 10-N collectively as the rectangular plates 10 unless the N rectangular plates 10-1 through 10-N need to be distinguished from each other for the sake of convenience of explanation.

The rectangular plates 10 are each a plate having a rectangular shape formed of two first sides opposed to each other and each having a length obtained by multiplying the predetermined value by a natural number, and two second sides opposed to each other and each having an arbitrary length. Further, the rectangular plates 10 can each be provided with one or more units not shown. The unit is, for example, a robot for performing a work operation on the object, a device other than the robot such as a material feeding device, a material removing device, or an inspection device, a jig, or an instrument. It should be noted that it is possible to provide the rectangular plate 10 with no unit at all.

On the rectangular plate 10 provided with the unit, the object is conveyed, and at the same time, some work operation is performed on the object. In contrast, on the rectangular plate 10 not provided with the unit, the object is conveyed, or nothing is performed. It should be noted that both of the rectangular plate 10 provided with the unit and the rectangular plate 10 not provided with the unit are each provided with a detection section (e.g., a sensor) for detecting presence or absence of a physical body (e.g., the object in the example) to be conveyed.

In the work system 1, the rectangular plates 10 are mounted on the mounting part 20 so as to be arranged in sequence toward the first direction A1 so that the first sides become parallel to the first direction A1. On this occasion, in the work system 1, the rectangular plates 10 are mounted on the mounting part 20 so that the interval between the rectangular plates 10 adjacent to each other in the first direction A1 becomes an integral multiple of a predetermined value. In the example shown in FIG. 1, the distances between the rectangular plates 10 adjacent to each other in the first direction A1 (i.e., the intervals between the rectangular plates 10 adjacent to each other in the first direction A1) are all 0 millimeter (no gap exists).

In such a work system 1, a first target rectangular plate 10 and a second rectangular plate 10 selected by the user from the rectangular plates 10 arranged in sequence on the mounting part 20 toward the first direction A1 can easily be exchanged for each other without moving or reassembling the rest of the rectangular plates 10. Thus, in the work system 1, it becomes easy to reorder the sequence of the operation processes performed in respective parts of the plurality of rectangular plates 10 arranged in the first direction A1. As a result, it is possible for the work system 1 to provide the user with a versatile usage corresponding to the object.

In the case in which, for example, it is attempted to exchange the orders of the work operation by a first unit provided to the rectangular plate 10-1 and the work operation by a second unit provided to the rectangular plate 10-3 for each other, it is possible for the user to easily exchange the orders of the work operation by the first unit and the work operation by the second unit for each other without moving or reassembling the rest of the rectangular plates 10, the rest of the units, and so on by exchanging the rectangular plate 10-1 provided with the first unit and the rectangular plate 10-3 provided with the second unit for each other. Here, the length in the first direction of each of the first unit and the second unit is a value equal to or smaller than a predetermined value.

Further, in the case in which, for example, it is attempted to exchange the orders of the work operation by a third unit provided so as to straddle the rectangular plate 10-1 and the rectangular plate 10-2 and the work operation by the second unit provided to the rectangular plate 10-3 for each other, it is possible for the user to easily exchange the orders of the work operation by the third unit and the work operation by the second unit for each other without moving the rest of the rectangular plates 10 by detaching the rectangular plate 10-3 provided with the second unit, then moving the rectangular plate 10-1 and the rectangular plate 10-2 provided with the third unit toward the first direction A1 as much as 100 millimeters (i.e., as much as the length in the first direction A1 of the rectangular plate 10-3 thus detached), and then mounting the rectangular plate 10-3 at the original position of the rectangular plate 10-1. Here, the length in the first direction A1 of the third unit is a value larger than the predetermined value.

It should be noted that although in the example shown in FIG. 1, the first sides on the −Y direction side of the rectangular plates 10 are aligned, this is illustrative only, and there is no need for the first sides to be aligned. Further, although in the example shown in FIG. 1, only the rectangular plate 10-3 is different in the length in the second direction A2 of the rectangular plates 10, this is also illustrative only, and any other rectangular plates can also be different in the length in the second direction A2, and it is also possible for all of the rectangular plates 10 to be different in the length in the second direction A2 from each other.

The mounting part 20 is a physical body, on which the plurality of plates can be mounted side by side so that the interval between the plates adjacent to each other in the first direction A1 becomes an integral multiple of a predetermined value, and is, for example, a pedestal. It should be noted that the mounting part 20 can also have a configuration in which the height in the Z-axis direction of the upper surface of the mounting part 20 is different between the places where the respective plates are mounted. Hereinafter, there is described, as an example, the case in which the surfaces, on which the respective plates are mounted, of the mounting part 20 are all included in the same plane, in other words, the surfaces are the same in height as each other. It should be noted that in this example, the mounting part 20 is a pedestal as a separate body from a floor surface. It should be noted that the mounting part 20 can also be the floor surface (or integrated with the floor surface), the ground, a wall surface, or the like providing the plurality of plates can be mounted.

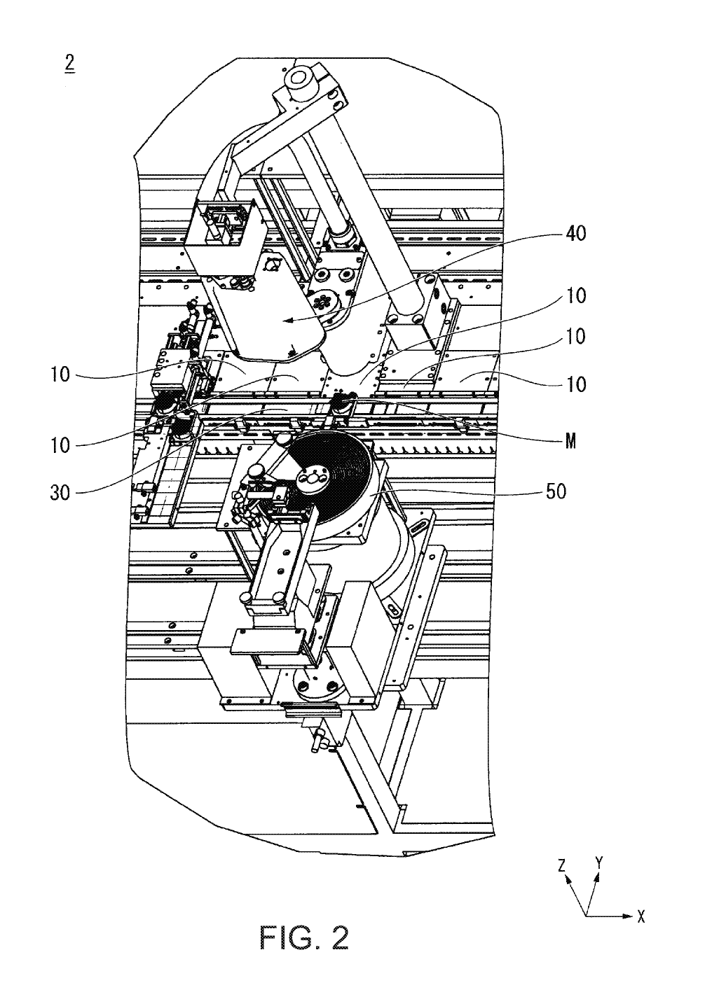

FIG. 2 is a diagram showing an example of a configuration of a part of a watch assembly line (a watch assembly system) 2 to which the work system 1 is applied. As the work system 1, a part of the watch assembly line 2 is provided with, for example, the plurality of rectangular plates 10, the mounting part 20 not shown in FIG. 2 for mounting the rectangular plates 10, a conveying section 30, a unit 40 provided to one of the rectangular plates 10, and a feed device 50 disposed so as to face the unit 40 across the conveying section 30. It should be noted that it is possible to adopt a configuration in which a part of the whole of the work system 1 is not provided with the conveying section 30. In the case in which the whole of the work system 1 is not provided with the conveying section 30, the object is conveyed in the first direction A1 by, for example, the user.

Further, the conveying section 30 provided to the work system 1 shown in FIG. 2 conveys the object in the first direction A1. The conveying section 30 is, for example, a belt conveyor. It should be noted that the conveying section 30 can also be another device capable of conveying the object such as a gravity conveyor or a robot instead of the belt conveyor. In FIG. 2, the conveying section 30 conveys the object M toward the first direction A1. In the example shown in FIG. 2, the object M is a component of a movement to be a content of a watch. In the case in which the conveying section 30 is the belt conveyor, the belt conveyor is supported by one or more of the rectangular plates 10. It should be noted that in the case in which the belt conveyor is supported by the plurality of rectangular plates 10 arranged in the first direction A1, a gap having a length of an integral multiple of a predetermined value can also exist between the rectangular plates 10 adjacent to each other in the first direction A1.

In this example, the unit 40 is a device for performing an action of picking up an embedded component fed by the feed device 50, and then fitting the embedded component thus picked up into the object M conveyed by the conveying section 30. The unit 40 is installed in one of the rectangular plates 10 provided to the work system 1.

The feed device 50 is a device for feeding the embedded component to a position where the unit 40 can pick up the embedded component. Further, the feed device 50 is a separate device from the rectangular plate 10 not provided to the rectangular plate 10 (i.e., a device not included in the unit). It should be noted that it is possible to adopt a configuration, in which the feed device 50 is provided to the rectangular plate 10, instead of the configuration, in which the feed device 50 is a separate body from the rectangular plate 10.

As described above, the work system 1 can be applied to an assembly line (a manufacturing line) provided with a plurality of manufacturing processes such as the watch assembly line 2. By applying the work system. 1, it is possible in the assembly line to easily reorder the sequence of the plurality of operation processes included in the work operation even in the case in which the sequence of the operation processes has been changed. Further, even in the case in which the design of the component or the product to be assembled, the assembly sequence, or the like has been changed, it is possible in the assembly line to easily perform the reassembly to the line corresponding to the design and the assembly sequence thus changed.

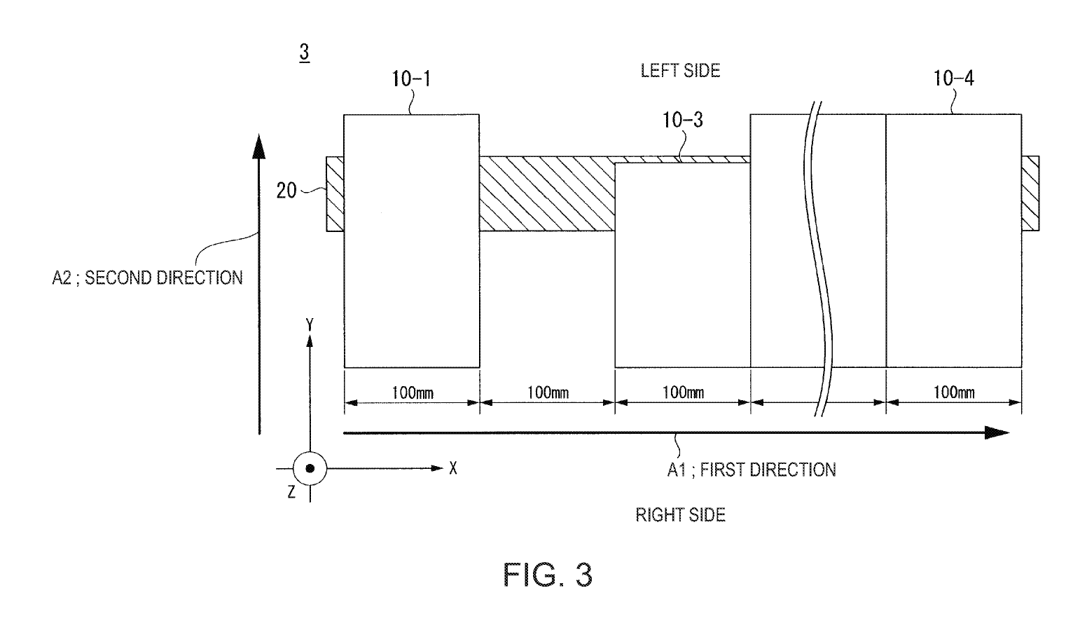

Such a work system 1 can also have a configuration in which at least one of the intervals between the rectangular plates 10 adjacent to each other in the first direction A1 is not 0 millimeter as in the case of the work system 3 shown in FIG. 3 in accordance with the manufacturing line to be embedded. In the work system 3, the interval between the rectangular plates 10 adjacent to each other in the first direction A1 is set (adjusted) to an integral multiple of a predetermined value as described above. FIG. 3 is a diagram showing an example of the plurality of rectangular plates 10 and a mounting part 20 constituting the work system 3. The configuration of the work system 3 shown in FIG. 3 is a configuration obtained by removing the rectangular plate 10-2 from the work system 1 shown in FIG. 1. In other words, the example shown in FIG. 3 is an example in which the interval between the rectangular plate 10-1 and the rectangular plate 10-3 out of the intervals between the rectangular plates 10 adjacent to each other in the first direction A1 is set to the same size as 100 millimeters as the predetermined value.

Thus, it is possible for the work system 3 to perform the work operation including the operation process performed by setting at least one of the intervals between the rectangular plates 10 adjacent to each other in the first direction A1 to a value obtained by multiplying 100 millimeters as the predetermined value by an integer equal to or larger than 1. As a result, the work system 3 has high versatility, and can be applied to a larger number of assembly lines. It should be noted that in the case in which the interval between the rectangular plates 10 adjacent to each other in the first direction A1 is not 0 millimeter as in the example shown in FIG. 3, for example, in the work system 1, the object is conveyed from the rectangular plate 10-1 to the rectangular plate 10-3 by the belt conveyor, a device dedicated to conveying different from a robot, a robot, or the like.

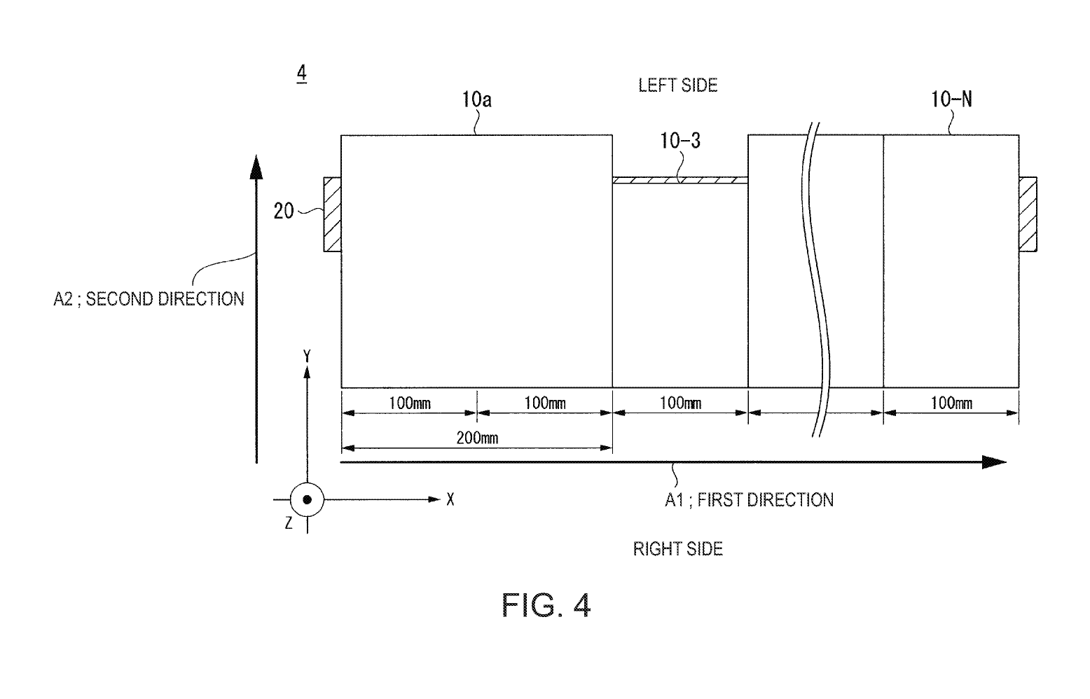

Further, it is also possible for the work system 1 to have a configuration of including a rectangular plate 10a having a length in the first direction A1 of a value, which is obtained by multiplying the predetermined value by a natural number equal to or larger than 2, as at least one of the rectangular plates 10 as in a work system 4 shown in FIG. 4. FIG. 4 is a diagram showing an example of the plurality of rectangular plates 10, the rectangular plate 10a, and the mounting part 20 constituting the work system 4. The configuration of the work system 4 shown in FIG. 4 is a configuration obtained by removing the rectangular plate 10-2 from the work system 1 shown in FIG. 1, and further including the rectangular plate 10a, which is the rectangular plate 10 obtained by changing the length in the first direction A1 of the rectangular plate 10-1 to be twice as large as 100 millimeters as the predetermined value.

Thus, in the work system 4, in the case in which, for example, it is attempted to perform the work operation by a fourth unit as the unit disposed straddling the two rectangular plates 10, it is possible to provide the fourth unit to the rectangular plate 10a having the length in the first direction A1 twice as large as 100 millimeters as the predetermined value. Further, in the work system 1, in the case in which it is attempted to exchange the orders of the work operation by the fourth unit and the work operation by a fifth unit provided to a single rectangular plate 10 for each other, it is possible to easily exchange the orders of the work operation by the fourth unit and the work operation by the fifth unit for each other by exchanging the rectangular plate 10 and the rectangular plate 10 adjacent to the rectangular plate 10 provided with the fifth unit and the rectangular plate 10a provided with the fourth unit for each other.

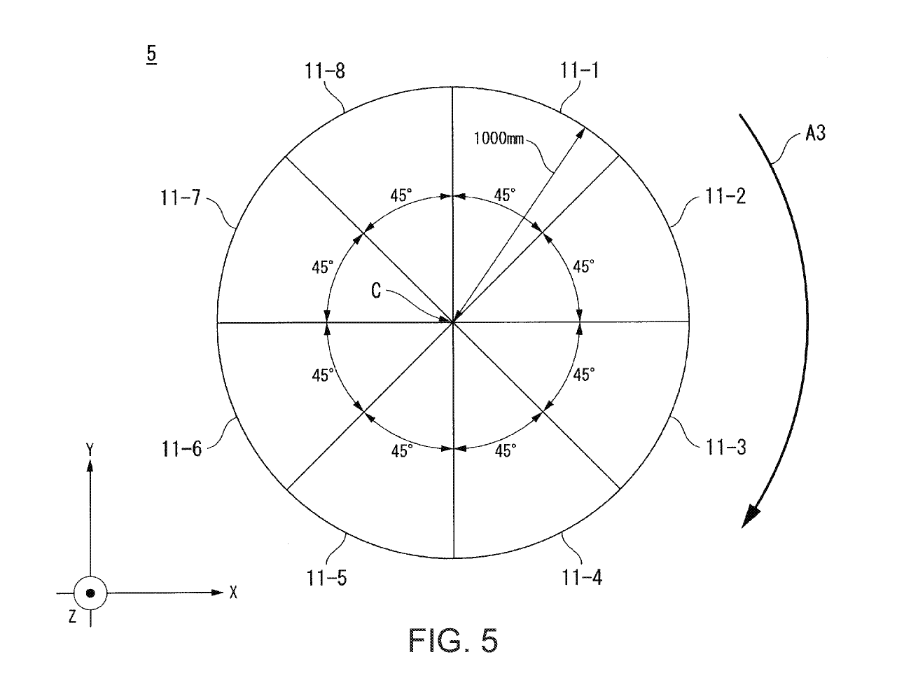

Further, it is also possible for the work system 1 to have a configuration provided with plates each having a different shape instead of the rectangular plates 10 as the plates each having the rectangular shape. For example, it is also possible for the work system 1 to have a configuration provided with sector plates 11 as plates each having a sector shape as in a work system 5 shown in FIG. 5. FIG. 5 is a diagram showing an example of the work system 5 provided with sector plates 11. The sector plates 11 are collective designations of the sector plates 11-1 through 11-8 shown in FIG. 5. The sector plates 11 are each a plate having, for example, a sector shape with a central angle of 45° and a radius of 1000 millimeters as shown FIG. 5. In FIG. 5, there are arranged the 8 sector plates 11, namely the sector plates 11-1 through 11-8, having the central angle of 45° so as to be adjacent to each other in a direction of the arrow A3 centered on the position C. The direction of the arrow A3 is a direction of a clockwise rotation centered on the position C. In this case, the direction of the arrow A3 corresponds to the first direction in which the work operation including the plurality of operation processes is performed. It should be noted that the direction of the arrow A3 can also be a direction of a counterclockwise rotation centered on the position C.

Further, in this case, the predetermined value is 250π millimeter as the length of the circular arc of each of the sector plates 11. Here, the symbol π denotes the circular constant. In FIG. 5, as an example, there is shown the case in which the length of each of the sector plates 11-1 through 11-8 is the same as the predetermined value. Further, in this case, in the work system 5, the intervals between the sector plates 11 adjacent to each other in the direction of the arrow A3 as the first direction are each set (adjusted) to an integral multiple of the predetermined value.

Due to the above, in the work system 5, it becomes easy to reorder the sequence of the operation processes performed in respective parts of the plurality of sector plates 11 arranged in the first direction. As a result, it is possible for the work system 5 to obtain substantially the same advantages as in the work system 1, and to provide the user with a versatile usage corresponding to the object.

Hereinafter, a mounting method of mounting the rectangular plates 10 and the rectangular plate 10a on the mounting part 20 in the work system 3 will be described citing the work system 3 as an example, and with reference to FIG. 6 and FIG. 7. More specifically, there will be described first attachment parts provided to each of the rectangular plates 10 and the rectangular plate 10a provided to the work system 3, and a second attachment part provided to the mounting part 20.

FIG. 6 is a diagram showing an example of the first attachment parts provided to the plurality of rectangular plates 10 and the rectangular plate 10a shown in FIG. 4. In the case of sectioning the rectangular plates 10 and the rectangular plate 10a provided to the work system 4 by 100 millimeters as the length of the predetermined value in the first direction A1, each of the rectangular plates 10 and the rectangular plate 10a is provided with the first attachment parts for attaching the own plate to the mounting part 20 at the same positions in every section.

The rectangular plates 10 each have the length in the first direction A1 equal to the predetermined value, and therefore have already been in the state of being sectioned by the length having the predetermined value. In contrast, the rectangular plate 10a has the length in the first direction A1 twice as large as the length of the predetermined value, and can therefore be sectioned into the two areas by separator lines BD1 through BD3 as shown in FIG. 6. Hereinafter, the explanation will be presented referring to the area on the −X direction side as a first area and the area on the +X direction side as a second area among these areas for the sake of convenience of explanation.

In this example, the rectangular plates 10 are each provided with the four first attachment parts. In FIG. 6, the first attachment parts are each a screw hole indicated by a filled circle on the surface of each of the rectangular plates 10. It should be noted that the first attachment part can also be another member such as a duct rail instead of the screw hole providing the member is for attaching the rectangular plate 10 to the mounting part 20. It is possible for the user to attach and fix each of the rectangular plates 10 to the mounting part 20 using the four first attachment parts in the rectangular plate 10.

Further, each of these four first attachment parts is disposed at roughly the same position in each of the rectangular plates 10. More specifically, each of the rectangular plates 10 is provided with the first attachment parts at the same positions in every section in the case of sectioning each of the rectangular plates 10 in the first direction A1 by the length of the predetermined value. In the example shown in FIG. 6, since the lengths in the first direction A1 of the respective rectangular plates 10 are all equal to the length of the predetermined value, the separators of the case of sectioning each of the rectangular plates 10 by the length of the predetermined value in the first direction A1 are only the two sides, namely the second side on the −X direction side of each of the rectangular plates 10 and the second side on the +X direction side.

In the example shown in FIG. 6, first one of the first attachment parts in each of the rectangular plates 10 has the center at a position, which is shifted as much as 15 millimeters from the second side located on the −X direction side of the rectangular plate 10 toward the +X direction, and is shifted as much as 180 millimeters from the first side located on the −Y direction side of the rectangular plate 10. In the case of, for example, the rectangular plate 10-N, the first one of the first attachment parts denotes the first attachment part H1 shown in FIG. 6. Further, second one of the first attachment parts in each of the rectangular plates 10 has the center at a position, which is shifted as much as 15 millimeters from the second side located on the −X direction side of the rectangular plate 10 toward the +X direction, and is shifted as much as 150 millimeters from the first side located on the −Y direction side of the rectangular plate 10. In the case of, for example, the rectangular plate 10-N, the second one of the first attachment parts denotes the first attachment part H2 shown in FIG. 6.

Further, third one of the first attachment parts in each of the rectangular plates 10 has the center at a position, which is shifted as much as 85 millimeters from the second side located on the −X direction side of the rectangular plate 10 toward the +X direction, and is shifted as much as 150 millimeters from the first side located on the −Y direction side of the rectangular plate 10. In the case of, for example, the rectangular plate 10-N, the third one of the first attachment parts denotes the first attachment part H3 shown in FIG. 6. Further, fourth one of the first attachment parts in each of the rectangular plates 10 has the center at a position, which is shifted as much as 85 millimeters from the second side located on the −X direction side of the rectangular plate 10 toward the +X direction, and is shifted as much as 180 millimeters from the first side located on the −Y direction side of the rectangular plate 10. In the case of, for example, the rectangular plate 10-N, the fourth one of the first attachment parts denotes the first attachment part H4 shown in FIG. 6.

Further, each of the first through fourth ones of the first attachment parts is also disposed with respect to each of the first area and the second area similarly to each of the rectangular plates 10. More specifically, first one of the first attachment parts in the first area denotes the first attachment part H11 shown in FIG. 6. The first attachment part H11 has the center at a position, which is shifted as much as 15 millimeters from the separator line BD1 toward the +X direction, and is shifted as much as 180 millimeters from the side located on the −Y direction side of the first area. Further, the second one of the first attachment parts in the first area denotes the first attachment part H12 shown in FIG. 6. The first attachment part H12 has the center at a position, which is shifted as much as 15 millimeters from the separator line BD1 toward the +X direction, and is shifted as much as 150 millimeters from the side located on the −Y direction side of the first area.

Further, the third one of the first attachment parts in the first area denotes the first attachment part H13 shown in FIG. 6. The first attachment part H13 has the center at a position, which is shifted as much as 85 millimeters from the separator line BD1 toward the +X direction, and is shifted as much as 150 millimeters from the side located on the −Y direction side of the first area. Further, the fourth one of the first attachment parts in the first area denotes the first attachment part H14 shown in FIG. 6. The first attachment part H14 has the center at a position, which is shifted as much as 85 millimeters from the separator line BD1 toward the +X direction, and is shifted as much as 180 millimeters from the side located on the −Y direction side of the first area.

It should be noted that the explanation of the second area is the same as the explanation in the case of replacing the “separator line BD1” in the explanation described above of the first area with the “separator line BD2,” the “first attachment part H11” with “first attachment part H21,” the “first attachment part H12” with “first attachment part H22,” the “first attachment part H13” with “first attachment part H23,” and the “first attachment part H14” with “first attachment part H24” in the explanation of the first area, and is therefore omitted.

Due to the configuration described above, in the work system 3, in the case of sectioning each of the rectangular plates 10 and the rectangular plate 10a by 100 millimeters as the length of the predetermined value in the first direction A1, by using the first attachment parts, the rectangular plates 10 can easily be attached to the mounting part 20 by the length of the predetermined value. As a result, in the work system 1, it becomes easy to reorder the sequence of the operation processes performed in respective parts of the plurality of rectangular plates 10 arranged in the first direction A1.

FIG. 7 is a diagram showing an example of second attachment parts provided to the mounting part 20 shown in FIG. 4. In the case of providing the sections of 100 millimeters as the length of the predetermined value in the first direction A1, the mounting part 20 is provided with the second attachment parts for attaching the rectangular plates 10 at the same positions in every section. In FIG. 7, the mounting part 20 is sectioned into N areas by N+1 separator lines, namely the separator lines B1 through BN+1. Hereinafter, the explanation will be presented referring to the separator lines B1 through BN+1 collectively as separator lines B unless the separator lines B1 through BN+1 need to be distinguished from each other. Further, the explanation will hereinafter be presented referring to the N areas as first through N^{th} attachment surfaces in sequence from the area on the −X direction side to the area on the +X direction side for the sake of convenience of explanation.

In this example, each of the first through N^{th} attachment surfaces is provided with the four second attachment parts. In FIG. 7, the second attachment parts are each a screw hole indicated by a filled circle on each of the attachment surfaces. It should be noted that the second attachment part can also be another member such as a duct rail instead of the screw hole providing the member is for attaching the rectangular plate 10 to the mounting part 20. It is possible for the user to attach and fix the rectangular plate 10 to each of the attachment surfaces using the four second attachment parts in the attachment surface.

Further, each of these four second attachment parts is disposed at roughly the same position in each of the attachment surfaces. For example, in the example shown in FIG. 7, first one of the second attachment parts has the center at a position, which is shifted as much as 15 millimeters from the separator line B located on the −X direction side of each of the attachment surfaces toward the +X direction, and is shifted as much as 40 millimeters from the side located on the −Y direction side of the attachment surface. In the case of, for example, the first attachment surface as the area sectioned by the separator line B1 and the separator line B2 in the mounting part 20, the first one of the second attachment parts denotes the second attachment part S1 shown in FIG. 7.

Further, second one of the second attachment parts has the center at a position, which is shifted as much as 15 millimeters from the separator line B located on the −X direction side of each of the attachment surfaces toward the +X direction, and is shifted as much as 10 millimeters from the side located on the −Y direction side of the attachment surface. In the case of, for example, the first attachment surface, the second one of the second attachment parts denotes the second attachment part S2 shown in FIG. 7.

Further, third one of the second attachment parts has the center at a position, which is shifted as much as 85 millimeters from the separator line B located on the −X direction side of each of the attachment surfaces toward the +X direction, and is shifted as much as 10 millimeters from the side located on the −Y direction side of the attachment surface. In the case of, for example, the first attachment surface, the third one of the second attachment parts denotes the second attachment part S3 shown in FIG. 7. Further, fourth one of the second attachment parts has the center at a position, which is shifted as much as 85 millimeters from the separator line B located on the −X direction side of each of the attachment surfaces toward the +X direction, and is shifted as much as 40 millimeters from the side located on the −Y direction side of the attachment surface. In the case of, for example, the first attachment surface, the fourth one of the second attachment parts denotes the second attachment part S4 shown in FIG. 7.

Due to the configuration described above, in the work system 1, in the case of sectioning the mounting part 20 by 100 millimeters as the length of the predetermined value in the first direction A1, by using the second attachment parts, the rectangular plates 10 can easily be attached to the mounting part 20 by the length of the predetermined value. As a result, in the work system 1, it becomes easy to reorder the sequence of the operation processes performed in respective parts of the plurality of rectangular plates 10 arranged in the first direction A1.

Further, in the case in which the attachment parts are disposed at the same positions in each of the sections obtained by sectioning each of the rectangular plates 10, the rectangular plate 10a, and the mounting part 20 by 100 millimeters as the predetermined length in the first direction A1 as shown in FIG. 6 and FIG. 7, namely at regular positions, it is possible to easily exchange and then attach, for example, the rectangular plate 10 having been attached at a certain position of the mounting part 20 and the rectangular plate 10 having been attached at another position of the mounting part 20 in the work system 3.

It should be noted that although in FIG. 1 through FIG. 5, and FIG. 6, there is described the case in which the work system 1 has the configuration in which the rectangular plates 10 are arranged in a straight line toward the first direction A1, the configuration of the work system 1 is not limited to this configuration. It is also possible for the work system 1 to have a configuration of a work system 6 not shown in which three work systems 1, namely work systems 1-1 through 1-3, are combined to form a bracket shape. In this case, it results that the first direction in which the work operation including a plurality of operation processes is performed rotates 90° at the corners of the bracket shape in the work system 6, namely a joint between the work system 1-1 and the work system 1-2 and a joint between the work system 1-2 and the work system 1-3. In this case, in the work system 6, the object is conveyed from the work system 1-1 to the work system 1-2, and from the work system 1-2 to the work system 1-3 using, for example, a robot or a dedicated conveying device. Thus, in the work system 6, it is possible to perform a work operation on the object while conveying the object along the bracket shape.

Further, for example, it is possible for the work system 1 to have a configuration of a composite system 7 provided with a first work system 1-4 for performing a work operation including a plurality of operation processes on a first object and a second work system 1-5 for performing a work operation, which includes a different operation process from the operation processes performed in the first work system 1-4, on a second object. For example, the first work system 1-4 is a work system for assembling a printer, and the first object is a component of the printer. Further, the second work system 1-5 is a work system for assembling a watch, and the second object is a component of the watch. In the composite system 7, the plate provided to the first work system 1-4 and the plate provided to the second work system 1-5 are both the rectangular plates 10. Due to this configuration, in the composite system 7, the rectangular plate 10 provided to the first work system 1-4 and the rectangular plate 10 provided to the second work system 1-5 are exchangeable for each other. Thus, it is possible for the composite system 7 to exchange the rectangular plates 10 between the two or more work systems. The two or more work systems are the works systems for assembling devices or products different from each other, respectively. Further, in the case of performing such exchange, in the case in which, for example, the rectangular plate 10 moved from the first work system 1-4 to the second work system 1-5 is provided with a unit, and the rectangular plate 10 moved from the second work system 1-5 to the first work system 1-4 is provided with a unit, the work operations performed by these units can easily be exchanged for each other in the composite system 7. Further, in the case in which, for example, the rectangular plate 10 moved from the first work system 1-4 to the second work system 1-5 is provided with the unit, and the rectangular plate 10 moved from the second work system 1-5 to the first work system 1-4 is not provided with a unit, the work operation having been performed by the first work system 1-4 can easily be incorporated in the second work system 1-5 in the composite system 7. Further, in the case in which, for example, the rectangular plate 10 moved from the first work system 1-4 to the second work system 1-5 is not provided with a unit, and the rectangular plate 10 moved from the second work system 1-5 to the first work system 1-4 is provided with the unit, the work operation having been performed by the second work system 1-5 can easily be incorporated in the first work system 1-4 in the composite system 7. As a result, the composite system 7 has high versatility. It should be noted that in the composite system 7, the combination of the first work system 1-4 and the second work system 1-5 is the combination of the work system for assembling the printer and the work system for assembling the watch, but can also be a combination of other work systems instead thereof. Further, although the configuration in which the composite system 7 is provided with the two work systems, namely the first work system 1-4 and the second work system 1-5, is described here, the composite system 7 can also have a configuration provided with three or more work systems instead thereof.

Further, the various lengths appearing in the explanation described above each include tolerance of ±5%.

As described hereinabove, in the work system 1 according to the embodiment, the lengths of the rectangular plates 10 in the first direction A1, in which the work process including the plurality of operation processes is performed, are each a value obtained by multiplying a predetermined value by a natural number, and an interval between the rectangular plates 10 adjacent to each other in the first direction A1 is a value obtained by multiplying the predetermined value by an integer. Thus, in the work system 1, it becomes easy to reorder the sequence of the operation processes performed in respective parts of the plurality of rectangular plates 10 arranged in the first direction A1. As a result, it is possible for the work system 1 to provide the user with a versatile usage corresponding to the object.

Further, in the work system 1, the intervals between the rectangular plates 10 adjacent to each other in the first direction A1 are all 0. Thus, in the work system 1, it is possible to perform the work operation including the operation processes, which are performed by setting all of the intervals between the rectangular plates 10 adjacent to each other in the first direction A1 to 0.

Further, in the work system 1, at least one of the intervals between the rectangular plates 10 adjacent to each other in the first direction A1 is a value obtained by multiplying the predetermined value by an integer equal to or larger than 1. Thus, it is possible for the work system 1 to perform the work operation including the operation processes, which are performed by setting at least one of the intervals between the rectangular plates 10 adjacent to each other in the first direction A1 to a value obtained by multiplying the predetermined value by the integer equal to or larger than 1.

Further, the work system 1 conveys an object in the first direction A1. Thus, in the work system. 1, it is possible to perform the work operation including operation processes, which are performed by conveying the object in the first direction A1.

Further, in the work system 1, an object is conveyed in the first direction A1 using the belt conveyor as the conveying section 30. Thus, in the work system 1, it is possible to perform the work operation including operation processes, which are performed by conveying the object in the first direction A1 using the belt conveyor.

Further, in the work system 1, in the case of sectioning each of the rectangular plates 10 in the first direction A1 by the length of the predetermined value, each of the rectangular plates 10 is provided with the first attachment parts at the same positions in every section. Thus, in the work system 1, it is possible to attach the rectangular plate 10 to another physical body by the length obtained by multiplying the predetermined value by a natural number using the first attachment parts.

Further, in the work system 1, in the case of providing the sections with the length of the predetermined value in the first direction A1, the mounting part 20 is provided with the second attachment parts for attaching the rectangular plates 10 at the same positions in every section. Thus, in the work system 1, it is possible to attach the rectangular plate 10 to the mounting part by the length obtained by multiplying the predetermined value by a natural number using the second attachment parts.

Further, in the work system 1, some or all of the plurality of rectangular plates 10 are provided with the units (e.g., the units 40) for the work operation. Thus, it is possible in the work system 1 to perform the operation processes by the units provided to some or all of the rectangular plates 10 in the respective operation processes.

Further, in the work system 1, at least one of the units is a robot. Thus, it is possible in the work system 1 to perform the operation process by the robot as at least one of the units in the operation process.

Further, in the work system. 1, the length of the unit in the first direction A1 is equal to or smaller than a predetermined value. Thus, it is possible in the work system 1 to provide the unit to each of the rectangular plates 10.

Further, in the work system 1, the plurality of rectangular plates 10 includes the rectangular plate 10 different in length in the second direction A2 perpendicular to the first direction A1. Thus, it is possible in the work system 1 to perform the work operation using the rectangular plate 10 having a length different in the second direction A2.

Further, in the work system 1, the predetermined value is 100 millimeters. Thus, in the work system 1, it becomes easy to reorder the sequence of the operation processes performed in respective parts of the rectangular plates 10 each having a length in the first direction A1 expressed by a round-off value. As a result, it is possible for the work system to provide the user with a versatile usage corresponding to the object.

Although the embodiment of the invention is hereinabove described in detail with reference to the accompanying drawings, the specific configuration is not limited to the embodiment described above, but modifications, replacement, elimination, and so on are allowed within the scope or the spirit of the invention.

The entire disclosure of Japanese Patent Application No. 2015-160327, filed Aug. 17, 2015 is expressly incorporated by reference herein.

What is claimed is:

1. A work system adapted to perform a work operation including a plurality of operation processes on an object, the work system comprising:
a plurality of plates,
wherein lengths of the plates in a first direction in which the work operation including the plurality of operation processes is performed each have a value obtained by multiplying a predetermined value by a natural number, and
intervals between the plates adjacent to each other in the first direction each have a value obtained by multiplying the predetermined value by an integer one of equal to and larger than 0.

2. The work system according to claim 1, wherein
the intervals between the plates adjacent to each other in the first direction are all 0.

3. The work system according to claim 1, wherein
at least one of the intervals between the plates adjacent to each other in the first direction has a value obtained by multiplying the predetermined value by an integer one of equal to and larger than 1.

4. The work system according to claim 1, further comprising:
a conveying section adapted to convey the object in the first direction.

5. The work system according to claim 4, wherein
the conveying section is a belt conveyor.

6. The work system according to claim 1, wherein
in a case of sectioning each of the plates in the first direction by the length of the predetermined value, each of the plates is provided with a first attachment part at a same position in every section.

7. The work system according to claim 1, further comprising:
a mounting part on which the plurality of plates is mounted,
wherein in a case of sectioning the mounting part in the first direction by the length of the predetermined value, the mounting part is provided with a second attachment part to which the plate is attached at a same position in every section.

8. The work system according to claim 1, wherein
some or all of the plates are each provided with a unit for the work operation.

9. The work system according to claim 8, wherein
at least one of the units is a robot.

10. The work system according to claim 8, wherein
the lengths of the units in the first direction are one of equal to and smaller than the predetermined value.

11. The work system according to claim 1, wherein
the plurality of plates includes the plate different in length in a second direction perpendicular to the first direction.

12. The work system according to claim 1, wherein
the predetermined value is 100 millimeters.

13. A composite system comprising:
a first work system as the work system according to claim 1; and
a second work system, which is the work system according to claim 1, and is provided with the operation process different from the operation process worked in the first work system,
wherein the plate provided to the first work system and the plate provided to the second work system are exchangeable for each other.

14. A composite system comprising:
a first work system as the work system according to claim 2; and
a second work system, which is the work system according to claim 2, and is provided with the operation process different from the operation process worked in the first work system,
wherein the plate provided to the first work system and the plate provided to the second work system are exchangeable for each other.

15. A composite system comprising:
a first work system as the work system according to claim 3; and
a second work system, which is the work system according to claim 3, and is provided with the operation process different from the operation process worked in the first work system,
wherein the plate provided to the first work system and the plate provided to the second work system are exchangeable for each other.

16. A composite system comprising:
a first work system as the work system according to claim 4; and
a second work system, which is the work system according to claim 4, and is provided with the operation process different from the operation process worked in the first work system,
wherein the plate provided to the first work system and the plate provided to the second work system are exchangeable for each other.

17. A composite system comprising:
a first work system as the work system according to claim 5; and
a second work system, which is the work system according to claim 5, and is provided with the operation process different from the operation process worked in the first work system,
wherein the plate provided to the first work system and the plate provided to the second work system are exchangeable for each other.

18. A composite system comprising:
a first work system as the work system according to claim 6; and
a second work system, which is the work system according claim 6, and is provided with the operation process different from the operation process worked in the first work system,
wherein the plate provided to the first work system and the plate provided to the second work system are exchangeable for each other.

19. A composite system comprising:
a first work system as the work system according to claim 7; and
a second work system, which is the work system according to claim 7, and is provided with the operation process different from the operation process worked in the first work system,
wherein the plate provided to the first work system and the plate provided to the second work system are exchangeable for each other.

20. A robotic system in which a robot performs a part or a whole of a plurality of operation processes on an object, the robotic system comprising:
the robot; and
a plurality of plates,
wherein some of the plates are provided with the robot,
lengths of the plates in a first direction in which a work operation including the plurality of operation processes is performed each have a value obtained by multiplying a predetermined value by a natural number, and
intervals between the plates adjacent to each other in the first direction each have a value obtained by multiplying the predetermined value by an integer one of equal to and larger than 0.
